(19) United States
(12) Patent Application Publication
(10) Pub. No.: US 2015/0300080 A1
(43) Pub. Date: Oct. 22, 2015

(54) SAFETY WINDOW GRID ASSEMBLY

(71) Applicant: ACCVAL L.L.C., Dover, DE (US)

(72) Inventor: Chen-Jui LIAO, Dover, DE (US)

(73) Assignee: ACCVAL L.L.C., Dover, DE (US)

(21) Appl. No.: 14/648,910

(22) PCT Filed: Dec. 6, 2012
(86) PCT No.: PCT/US12/68298

§ 371 Date: Jun. 1, 2015

(51) Int. Cl. E06B 9/18; E06B 5/10; E06B 9/01; E06B 5/11

(52) U.S. Cl. CPC E06B 9/18; E06B 5/11; E06B 5/103; E06B 9/01; E06B 2009/002

(57) ABSTRACT

A safety window grid assembly includes a window frame unit and a grid-forming unit. The grid-forming unit includes: a rotatable shaft supported rotatably on the window frame unit; a plurality of cords, each of which has a first connecting end secured to the rotatable shaft and each of which is extendably wound on the rotatable shaft, each of the cords being retractable and extendable between a retracted state and an extended state, the cords being helical in shape and being distributed in series along the length of the rotatable shaft when the cords are disposed at the retracted state; and a connecting mechanism for interconnecting a second connecting end of each cord of the grid structure and the window frame unit.

### BACKGROUND

1. Field

This technology relates to a safety window grid assembly, more particular to a safety window grid assembly including a plurality of cords which are helically and extendably wound on a rotatable shaft and which form a grid structure when disposed at an extended state.

2. Description of the Related Art

U.S. Pat. No. 4,495,727 discloses a conventional anti-theft window bar assembly or a safety window bar assembly designed to discourage thieves or prevent small children from falling through a window. The window bar assembly includes supporting bars, horizontal rigid bars extending through the supporting bars, and holder elements connected to the supporting bars and fastened to a window frame unit through fasteners. The window bar assembly is fixed in shape before being mounted to the window frame unit, and the shape of which cannot be adjusted once the supporting bars and the horizontal rigid bars are assembled together. U.S. Patent Application Pub. No. 2007/0227676 discloses a window assembly that incorporates a retractable screen assembly and that includes an external frame configured to interfere with a rectangular opening in a wall, a stationary panel, and a sliding panel configured to slide within the confines of the external frame between open and closed positions. The retractable screen assembly includes a spool and a screen rolled about the spool and having a leading end coupled to the sliding panel such that the screen is co-movable with the sliding panel. The screen is fixed in shape before being coupled to the sliding panel, and the shape of which cannot be adjusted.

### SUMMARY

With the present technology an attempt is made to provide a safety window grid assembly that is shape-adjustable to form a grid structure with varying shape according to actual requirements.

According to the present technology, there is provided a safety window grid assembly that comprises a window frame unit and at least one grid-forming unit. The grid-forming unit includes: a rotatable shaft supported rotatably on the window frame unit; a plurality of cords, each of which having a first connecting end secured to the rotatable shaft and a second connecting end, and each of which is extendably wound on the rotatable shaft, each of the cords being retractable and extendable relative to the rotatable shaft between a retracted state and an extended state, the cords being helical in shape and being distributed in series along the length of the rotatable shaft when the cords are disposed at the retracted state, the cords being unwound from the rotatable shaft to form a grid structure when the cords are disposed at the extended state; and a connecting mechanism for interconnecting the second end of each of the cords of the grid structure and the window frame unit.

### BRIEF DESCRIPTION OF THE DRAWINGS

In drawings which illustrate embodiments of the invention,

FIG. 1 is a schematic view of the first preferred embodiment of a safety window grid assembly according to the present invention;

FIG. 2 is a perspective view to illustrate the structure of a grid-forming unit of the first preferred embodiment;

FIG. 3 is an exploded perspective view to illustrate the structure of the grid-forming unit of the first preferred embodiment;

FIG. 4 is a schematic side view illustrating a state where a pawl engages a ratchet of the first preferred embodiment;

FIG. 5 is a schematic side view illustrating another state where the pawl disengages the ratchet of the first preferred embodiment;

FIG. 6 is a sectional view illustrating a state where cords of the first preferred embodiment are disposed at a retracted state;

FIG. 7 is a sectional view illustrating a state where the cords of the first preferred embodiment are cut into desired lengths according to actual requirements;

FIG. 8 is a schematic view illustrating a state where the first preferred embodiment having the cords cut into desired lengths are mounted to a non-rectangular (trapezoid) window wall;

FIG. 9 is a schematic view of the second preferred embodiment of the safety window grid assembly according to the present invention;

FIG. 10 is a schematic view of the third preferred embodiment of the safety window grid assembly according to the present invention;

FIG. 11 is a sectional view of the fourth preferred embodiment of the safety window grid assembly according to the present invention;

FIG. 12 is a sectional view of the fifth preferred embodiment of the safety window grid assembly according to the present invention; and

FIG. 13 is a fragmentary sectional view of the sixth preferred embodiment of the safety window grid assembly according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

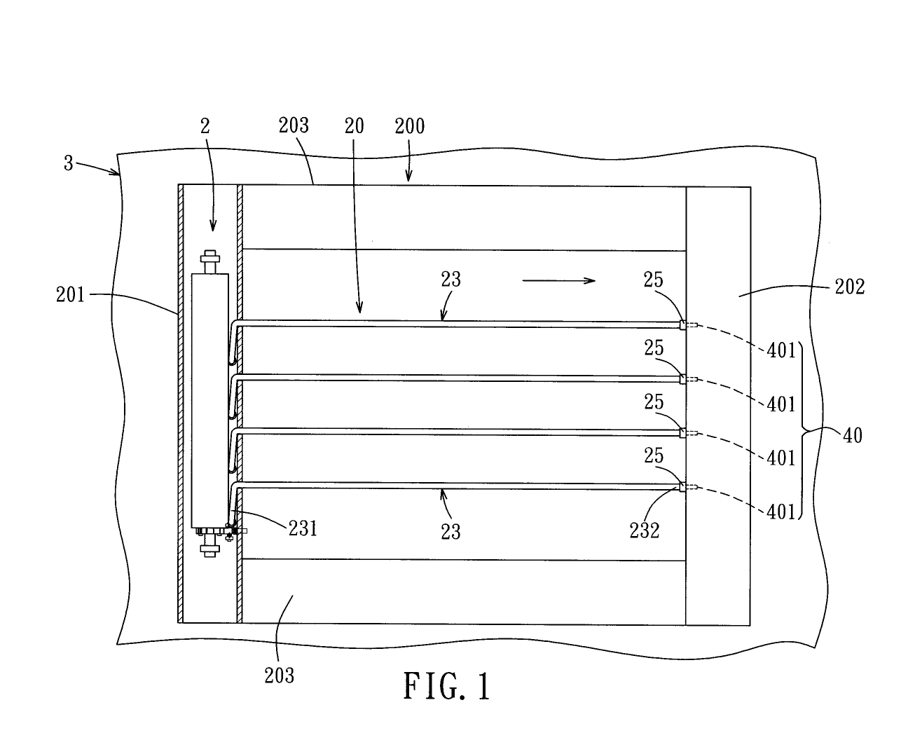

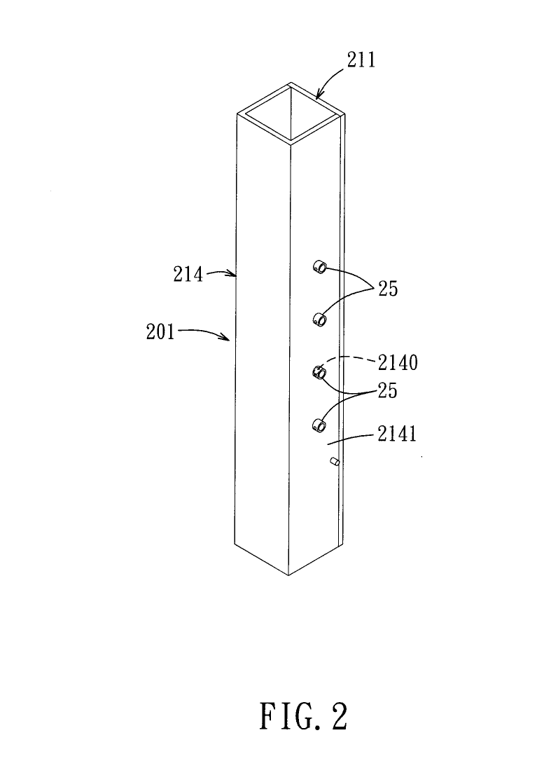

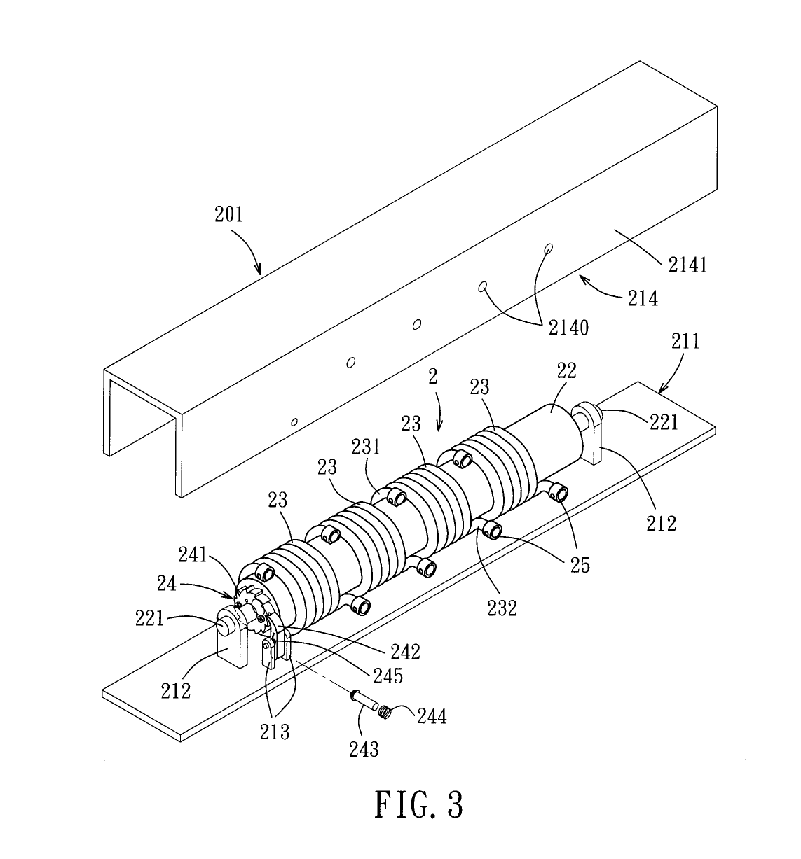

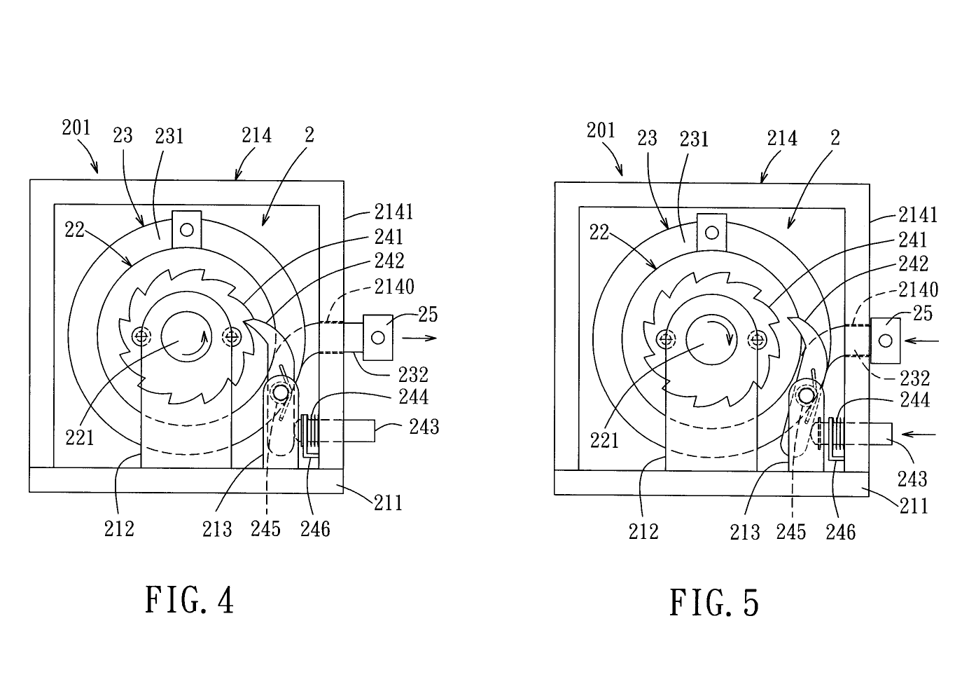

FIG. 1, in combination with FIGS. 2 to 5, illustrates the first preferred embodiment of a safety window grid assembly for mounting to a building wall 3 according to the present invention. The safety window grid assembly includes a window frame unit 200 and a grid-forming unit 2.

The window frame unit 200 is rectangular in shape, and includes first and second supporting bars 201, 202 and two opposite interconnecting bars 203 interconnecting the first and second supporting bars 201, 202. The first supporting bar 201 has a base plate 211 provided with two opposite bearing seats 212 and a pair of pawl seats 213, and a cover 214 secured to the base plate 211.

The grid-forming unit 2 includes: a rotatable shaft 22 supported rotatably on the first supporting bar 201 of the window frame unit 200; a plurality of cords 23, each of which is extendably wound on the rotatable shaft 22 and each of which has first and second connecting ends 231, 232; a rotation controlling mechanism 24; a plurality of stoppers 25, each of which is detachably connected to the second connecting end 232 of a respective one of the cords 23; and a connecting mechanism 40.

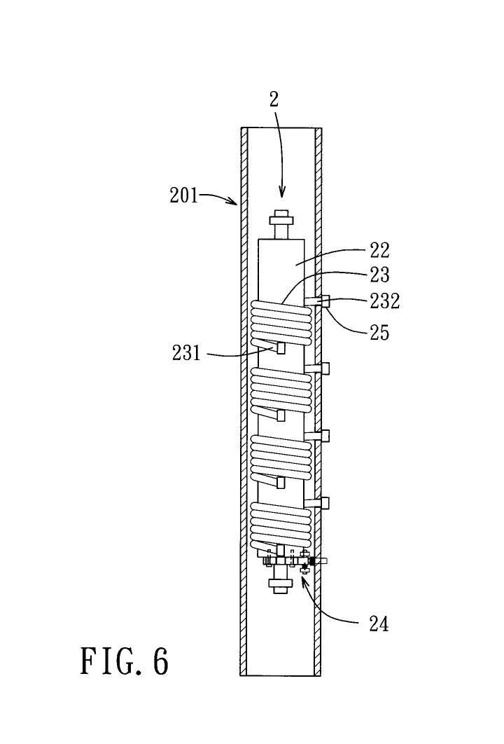

The first connecting end 231 of each of the cords 23 is secured to the rotatable shaft 22. Each of the cords 34 is retractable and extendable relative to the rotatable shaft 22 between a retracted state (see FIG. 6) and an extended state (see FIG. 1). The cords 23 are helical in shape and are distributed in series along the length of the rotatable shaft 22 when the cords 23 are disposed at the retracted state. The cords 23 are unwound from the rotatable shaft 22 to form a grid structure 20 when the cords 23 are disposed at the extended state.

Preferably, the rotatable shaft 22 is made from a metallic material, such as stainless steel. Each of the cords 23 has a twisted strand of wires of a metallic material, such as stainless steel. The first connecting end 231 of each of the cords 23 is secured to the rotatable shaft 22 by welding. The twisted strand of the wires of each of the cords 23 has an elasticity such that each of the cords 23 exhibits a spring-like property that accumulates a restoring force when each of the cords 23 is extended from the retracted state to the extended state. Alternatively, each of the cords 23 can further have an elastic sheath (not shown) wrapping around the twisted strand of the wires for enhancing the spring-like property of each of the cords 23.

In this embodiment, the rotatable shaft 22 has two end portions 221 journaled to the bearing seats 212, respectively. The cover 214 covers the rotatable shaft 22. Each of the cords 23 extends through a respective one of holes 2140 in a side wall 2141 of the cover 214.

The rotation controlling mechanism 24 includes a ratchet 241 secured to and surrounding one of the end portions 221 of the rotatable shaft 22, a pawl 242 pivoted to the pawl seats 213 and engaging releasably the ratchet 241, a torsion spring 245 connected to one of the pawl seats 213 and the pawl 242 to urge the pawl 242 toward the ratchet 241, a spring-biased releasing button 243 movably mounted on the cover 214 through a confining plate 246 and movable from an original position to a pressing position to move the pawl 242 to be disengaged from the ratchet 241, and a coil spring 244 sleeved on the releasing button 243 for restoring the releasing button 243 to its original position. As such, the rotatable shaft 22 is permitted to rotate in a rotational direction upon unwinding of the cords 23, and is prevented from rotating in an opposite rotational direction by the engagement between the pawl 242 and the ratchet 241. In order to permit the rotatable shaft 22 to rotate in the rotational direction, the releasing button 243 can be pressed to release the ratchet 241 from the pawl 242. As such, the cords 23 can be retracted from the extended state by virtue of their own spring-like property and rewound on the rotatable shaft 22.

FIG. 1 shows how the safety window grid assembly is installed to a rectangular window opening in the building wall 3. In this embodiment, the connecting mechanism 40 includes a plurality of screw fasteners 401 for interconnecting the stoppers 25 and the second supporting bar 202. The window frame unit 200 can be securely mounted to the building wall 3 in a conventional manner. After mounting to the building wall 3, the cords 23 are subsequently extended to the extended state to form the grid structure 20, followed by fixing the stoppers 25 to the second supporting bar 202 through the screw fasteners 401 of the connecting mechanism 40. Alternatively, the connecting mechanism 40 can be a solder material (not shown) that is connected to the stoppers 25 and the second supporting bar 202 through welding techniques.

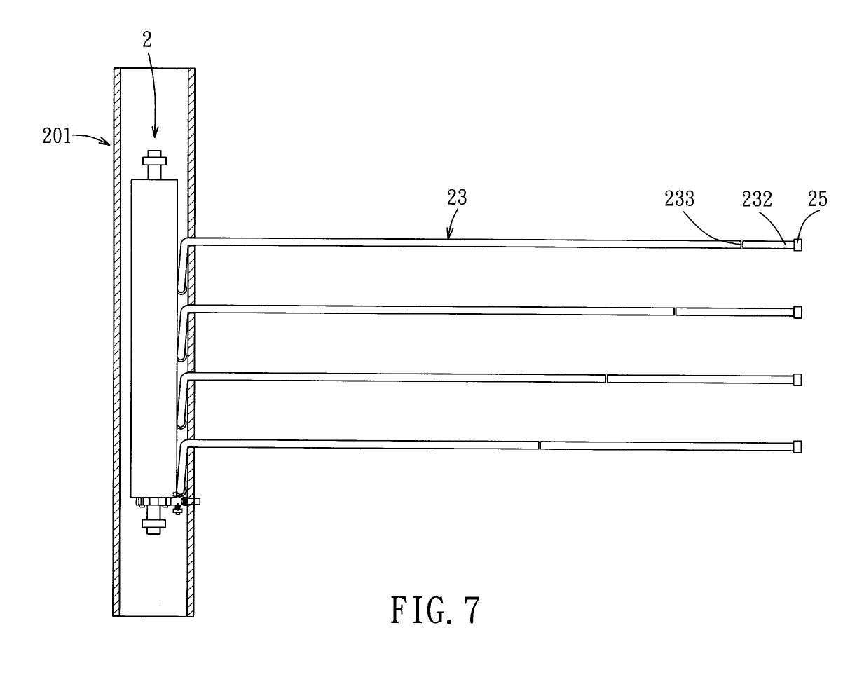

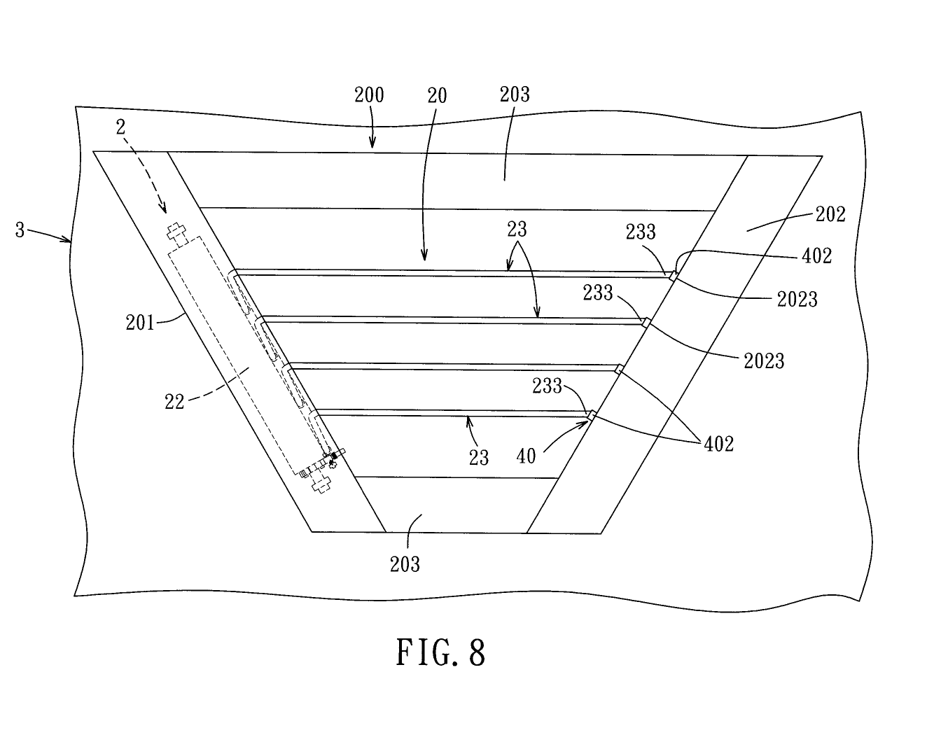

Referring to FIGS. 7 and 8, when the safety window grid assembly 2 is to be applied to a non-rectangular (trapezoid) window opening in the building wall 3, the cords 23 are extended to the extended state, followed by cutting the cords 23 such that each of the cords 23 has a length substantially equal to the distance between the first connecting end 231 of the cord 23 and a connecting point 2023 of the second supporting bar 202 to which the cord 23 is to be fixed, then fixing the window frame unit 200 to the building wall 3, fixing free ends 233 of the cords 23 to connecting blocks 402 of a connecting mechanism 40 by welding techniques, and finally fixing the connecting blocks 402 to the connecting points 2023 of the second supporting bar 202 by welding techniques, thereby forming a trapezoid grid structure 20 on the window frame unit 200.

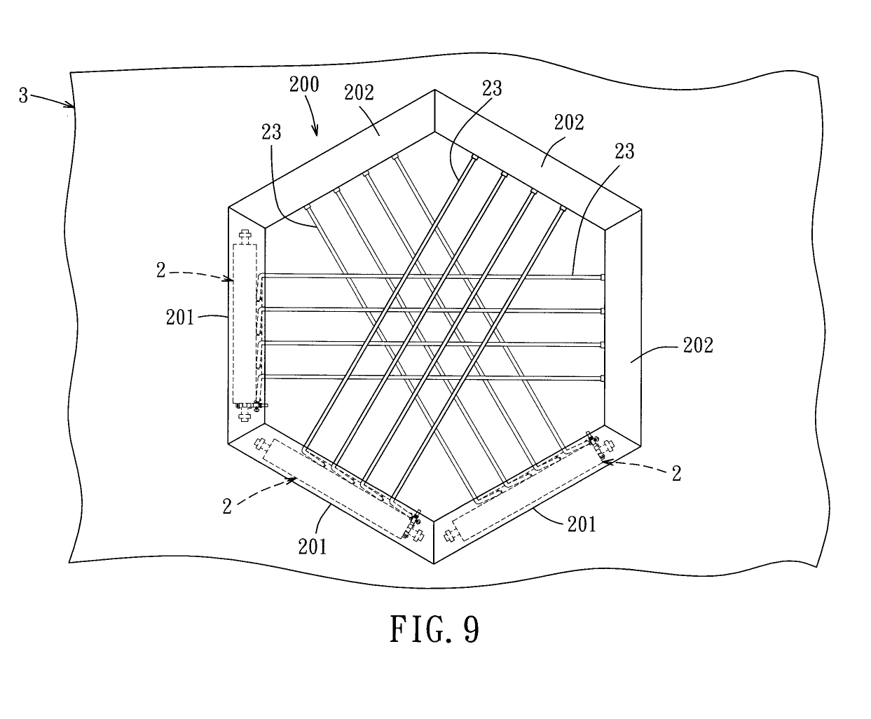

FIG. 9 illustrates the second preferred embodiment of the safety window grid assembly for application to a hexagonal window opening in the building wall 3 according to the present invention. The safety window grid assembly includes a hexagonal window frame unit 200 and three grid-forming units 2 having a structure the same as that of the first preferred embodiment. The window frame unit 200 includes three pairs of opposite first and second supporting bars 201, 202. The grid-forming units 2 are mounted respectively to the first supporting bars 201, and form three grid structures 20, when the cords 23 of the grid-forming units 2 are disposed at the extended state. The three grid structures 20 cross one another.

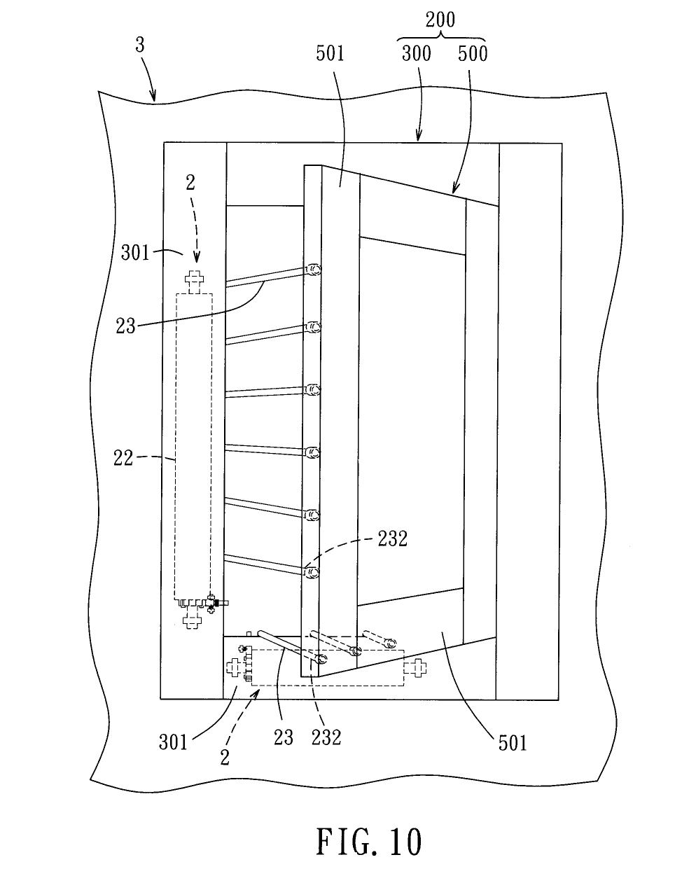

FIG. 10 illustrates the third preferred embodiment of the safety window grid assembly for application to the building wall 3 according to the present invention. The safety window grid assembly serves as a push-out window, and includes a window frame unit 200 and two grid-forming units 2 having a structure the same as that of the first preferred embodiment. The window frame unit 200 includes an outer frame 300 and an inner frame 500 pivoted to the outer frame 300 so as to be rotatable relative to the outer frame 300. The outer frame 300 has two outer supporting bars 301 that are connected to each other to form an L-shaped configuration. The inner frame 500 has two inner supporting bars 501 that are connected to each other to form an L-shaped configuration. The grid-forming units 2 are mounted to the outer supporting bars 301, respectively, and the second connecting ends 232 of the cords 23 of each of the grid-forming units 2 are secured to a respective one of the inner supporting bars 501 so that the grid-forming units 2 form two grid structures 20 on two different planes, respectively, when the inner frame 500 is pushed out relative to the outer frame 300 to dispose the cords 23 of the grid-forming units at the extended state. The two planes are perpendicular to each other.

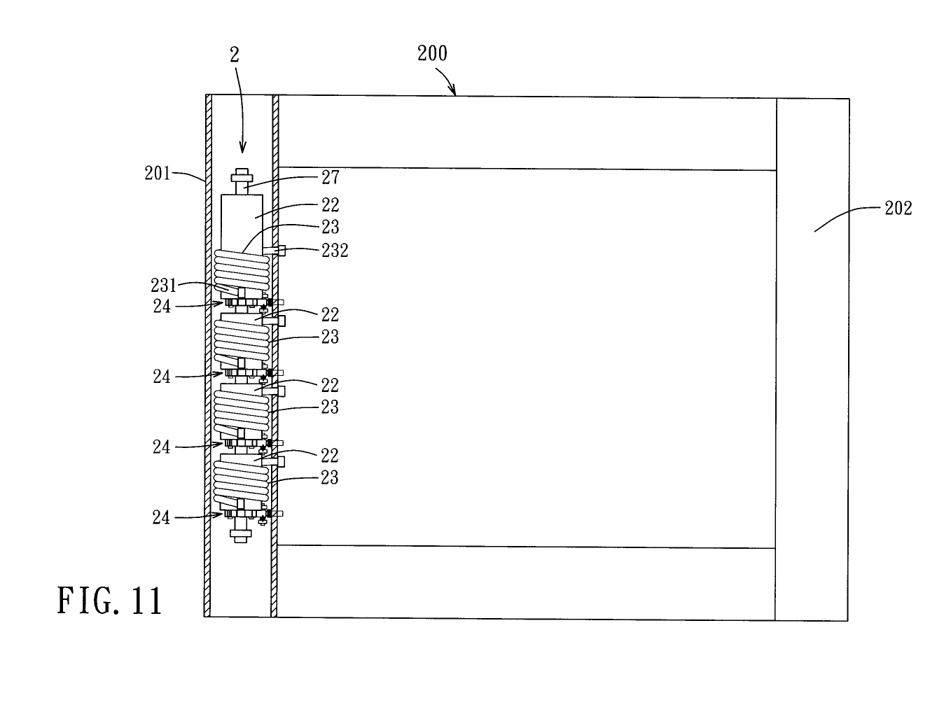

FIG. 11 illustrates the fourth preferred embodiment of a safety window grid assembly 2 according to the present invention. The safety window grid assembly of the fourth preferred embodiment has a structure similar to that of the first embodiment, except that the grid-forming unit 2 includes a plurality of rotatable shafts 22 supported rotatably on the window frame unit 200 and a plurality of rotation controlling mechanisms 24 coupled to the rotatable shafts 22, respectively, and that each of the cords 23 has a connecting end 231 secured to a respective one of the rotatable shafts 22 and is extendably and helically wound on the respective one of the rotatable shafts 22. Each of the cords 23 is retractable and extendable relative to the respective one of the rotatable shafts 22 between the retracted state and the extended state (not shown). In this embodiment, the grid-forming unit 2 further includes a fixed shaft and a plurality of bearings (not shown). The rotatable shafts 22 are rotatably journaled to the fixed shaft 27 through the bearings. Since the cords 23 are independent from one another, each of the cords 23 can be pulled to a length that is independent from those of others of the cords 23.

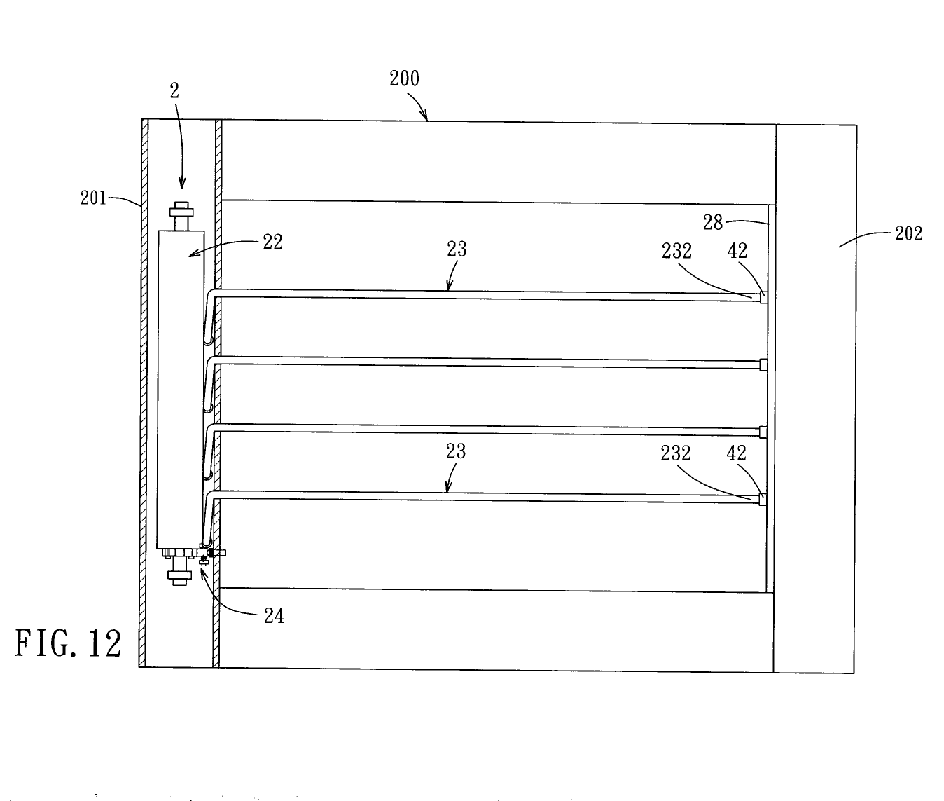

FIG. 12 illustrates the fifth preferred embodiment of the safety window grid assembly according to the present invention. The fifth preferred embodiment differs from the first preferred embodiment in that the fifth preferred embodiment further includes a pulling bar 28 and that the second connecting end 232 of each of the cords 23 is releasably connected to the pulling bar 28 through a fastener 42 so that the cords 23 can be simultaneously pulled to move from the retracted state to the extended state by pulling the pulling bar 28. In addition, the pulling bar 28 can be fixed to the second supporting bar 202 in a conventional manner, such as by welding or using screw fasteners (not shown).

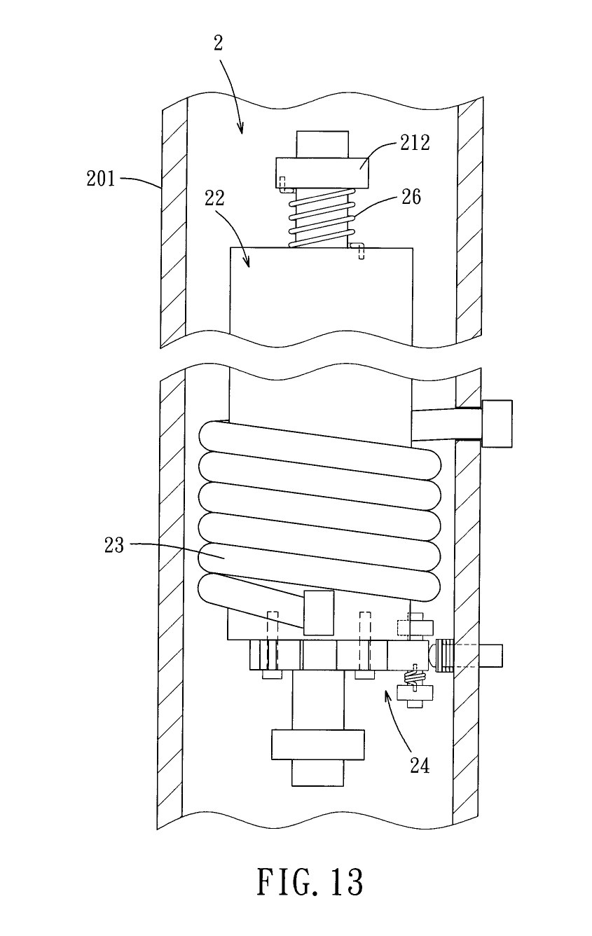

FIG. 13 illustrates the sixth preferred embodiment of the safety window grid assembly according to the present invention. The sixth preferred embodiment differs from the first preferred embodiment in that the sixth preferred embodiment further includes a shaft-urging spring 26 interconnecting the rotatable shaft 22 and one of the bearing seats 212 so as to accumulate a restoring force when the rotatable shaft 22 is driven to rotate about its axis by movement of the cords 23 from the retracted state to the extended state.

With the inclusion of the cords 23, which are helically and extendably wound on and distributed along the rotatable shaft 22, in the grid-forming unit 2 of the safety window grid assembly of this invention, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the scope of the broadest interpretation so as to encompass all such modifications and equivalent arrangements.

All elements, parts and steps described herein are preferably included. It is to be understood that any of these elements, parts and steps may be replaced by other elements, parts and steps or deleted altogether as will be obvious to those skilled in the art.

Broadly, this writing discloses: A safety window grid assembly includes a window frame unit and a grid-forming unit. The grid-forming unit includes: a rotatable shaft supported rotatably on the window frame unit; a plurality of cords, each of which has a first connecting end secured to the rotatable shaft and each of which is extendably wound on the rotatable shaft, each of the cords being retractable and extendable between a retracted state and an extended state, the cords being helical in shape and being distributed in series along the length of the rotatable shaft when the cords are disposed at the retracted state; and a connecting mechanism for interconnecting a second connecting end of each cord of the grid structure and the window frame unit.

Concepts

This writing discloses at least the following concepts.

Concept 1. A safety window grid assembly comprising:
a window frame unit; and
at least one grid-forming unit including
   a rotatable shaft supported rotatably on said window frame unit,
   a plurality of cords, each of which has a first connecting end secured to said rotatable shaft and a second connecting end, and each of which is extendably wound on said rotatable shaft, each of said cords being retractable and extendable relative to said rotatable shaft between a retracted state and an extended state, said cords being helical in shape and being distributed in series along the length of said rotatable shaft when said cords are disposed at the retracted state, said cords being unwound from said rotatable shaft to forma grid structure when said cords are disposed at the extended state, and
   a connecting mechanism for interconnecting said second end of each of said cords of said grid structure and said window frame unit.

Concept 2. The safety window grid assembly of Concept 1, wherein each of said cords exhibits a spring-like property that accumulates a restoring force when each of said cords is extended from the retracted state to the extended state.

Concept 3. The safety window grid assembly of Concept 1, wherein each of said cords is made from a metallic material.

Concept 4. The safety window grid assembly of Concept 1, wherein said connecting mechanism is in the form of a pulling bar connected to said second connecting ends of said cords.

Concept 5. The safety window grid assembly of Concept 1, further comprising a ratchet secured to said rotatable shaft, and a pawl mounted movably on said window frame unit and engageable with said ratchet.

What is claimed is:

1. A safety window grid assembly comprising:
a window frame unit; and
at least one grid-forming unit including
a rotatable shaft supported rotatably on said window frame unit,
a plurality of cords, each of which has a first connecting end secured to said rotatable shaft and a second connecting end, and each of which is extendably wound on said rotatable shaft, each of said cords being retractable and extendable relative to said rotatable shaft between a retracted state and an extended state, said cords being helical in shape and being distributed in series along the length of said rotatable shaft when said cords are disposed at the retracted state, said cords being unwound from said rotatable shaft to forma grid structure when said cords are disposed at the extended state, and
a connecting mechanism for interconnecting said second end of each of said cords of said grid structure and said window frame unit.

2. The safety window grid assembly of claim 1, wherein each of said cords exhibits a spring-like property that accumulates a restoring force when each of said cords is extended from the retracted state to the extended state.

3. The safety window grid assembly of claim 1, wherein each of said cords is made from a metallic material.

4. The safety window grid assembly of claim 1, wherein said connecting mechanism is in the form of a pulling bar connected to said second connecting ends of said cords.

5. The safety window grid assembly of claim 1, further comprising a ratchet secured to said rotatable shaft, and a pawl mounted movably on said window frame unit and engageable with said ratchet.
